(19) United States
(12) Patent Application Publication
(10) Pub. No.: US 2009/0235312 A1
(43) Pub. Date: Sep. 17, 2009

(54) Targeted content with broadcast material

(76) Inventors: Amir Morad, Tel-Aviv (IL); Leonid Yavits, Herzlia (IL); Tomer Y. Morad, Tel-Aviv (IL)

Correspondence Address: MARTIN D. MOYNIHAN d/b/a PRTSI, INC., P.O. BOX 16446, ARLINGTON, VA, 22215, US

(21) Appl. No.: 11/818,971

(22) Filed: Mar. 11, 2008

(51) Int. Cl. G06F 3/00; G06Q 30/00

(52) U.S. Cl. 725/44; 705/14

(57) ABSTRACT

User end communication apparatus for managing broadcast channel input within a user end environment, comprises: a channel probe for obtaining channel context data from a stream at least passing through said user end communication apparatus; a keyword/key concept extractor for extracting channel keywords from the channel context data; and a content selector for selecting a content item or stream for mixing into a channel currently being viewed based on the channel keyword/key concept.

### FIELD AND BACKGROUND OF THE INVENTION

The present invention relates to apparatus and a method for providing targeted content with broadcast material and, more particularly, but not exclusively to targeted insertion of content into or alongside a broadcast stream based at least partly on information available.

Targeting of content allows in-context information for users, in-context activity and furthermore is useful for advertising, in that it can be used to provide advertising which is more focused on the recipient and therefore gives a greater return to the advertiser. Targeted advertising is known on the Internet where individual users order their own content, and advertising can be based on the content ordered by the user. For example Google™ search results are accompanied by advertising which is selected based at least partly on the search terms in context as provided by the user. That is to say in-context keywords and phrases are extracted and used to select relevant advertising.

In broadcasting, where a single stream of content is provided as a channel to all users, it is common to include advertising as part of the channel stream. However the advertising is common to all users and no attempt is made at targeting. Many television channels do not even allow targeting based on the program content, in that they sell advertising slots in advance of publication of the broadcast schedules, or even if they publish the schedules, targeting is only possible based on the broad subject of the program. Advertisers pay different rates depending on the viewing figures for the channel, for slots during peak viewing times etc, but they cannot for example insert an advertisement at a point in a program that is relevant to a product they are selling. They certainly cannot target individual viewers. The most they can do is to target the typical audience of a given program.

US Patent Application No. 2002/0144261 teaches adverts that are selected for individual users at the set top box. More particularly the broadcaster sends a generic trigger to indicate an advertising break, which is then translated into a specific trigger at the set top box. The user has a profile with key words and the advertisements are provided with key words. The specific trigger uses the two sets of key words to trigger advertisements which fit with a user profile.

The user profile is constructed by adding keywords based on kinds of programs watched. The user profile is held at the set top box so as to uphold the viewer's data privacy. The adverts are transmitted as dormant computer programs which are executed upon triggering by the specific trigger.

### SUMMARY OF THE INVENTION

The above prior art does not provide a way of using a currently broadcast channel, or any like media stream, as a source for context for advertising.

The present invention, in some aspects thereof, relates to apparatus and a method for extracting context information at the user end from broadcast material to support in-context activities in association with viewing. In order for the context to be current, the extraction process may be low latency, and this is helped by carrying out the extraction process at the user end.

The present invention in one aspect allows the local set top box or modem or other local communication equipment to set the trigger, so that there is no longer any need to rely on the broadcaster. In another aspect keywords are extracted from the channel being broadcast or any other channel stream, preferably in real time and on a continuous basis, so that the advertisements are chosen in accordance with the keywords, key phrases or key concepts extracted from the multimedia streams received from the channel or downloaded from Internet or otherwise, and/or based on their relevancy to the viewing experience, and are continuously exchanged without user interaction.

According to an aspect of some embodiments of the present invention there is provided user end communication apparatus for managing broadcast channel input within a user end environment, the apparatus comprising:

a channel probe for obtaining channel context data from a stream at least passing through the user end communication apparatus;

a keyword extractor for extracting channel key information from the channel context data; and

a content selector for selecting a content item for mixing into a channel currently being viewed based on the channel keyword.

In an embodiment, the channel probe is configured to obtain the channel context data from at least one member of the group comprising closed captions and subtitles included within the stream.

An embodiment may comprise a database of content items for selection by the content selector based a comparison with the channel context data.

In an embodiment, the comparison is a soft comparison.

In an embodiment, the channel probe is configured to obtain the channel context data by image analysis of the channel.

In an embodiment, the channel probe is configured to obtain the channel context data from audio analysis of the channel.

In an embodiment, the stream selector comprises a prioritizing unit for making a comparison between the channel key information and a locally stored user profile, thereby to prioritize content items from the database which are indicated as relevant by the user profile.

In an embodiment, the prioritizing unit is configured to make a soft comparison.

In an embodiment, the stream selector is configured to obtain a link to the content stream for mixing, using one of the extracted channel keywords.

In an embodiment, wherein the mixing comprises providing a user activatable control on a screen in association with the channel currently being viewed.

In an embodiment, the stream selector is configured to provide a pop-up window on a screen in association with the channel being played.

In an embodiment, the stream selector is configured to provide a banner display on a screen in association with the channel being played.

In an embodiment, the stream at least passing is the channel being viewed.

In an embodiment, the stream selector is configured to buffer the channel being viewed while a content stream related to the predetermined keyword is mixed into the channel being viewed for playing.

In an embodiment, the buffering is for a variable time set by a length of the content stream.

In an embodiment, the stream selector is configured to mix in the content stream following receipt of a trigger from a head end.

In an embodiment, the stream selector is configured to mix in the content following local triggering by a user.

In an embodiment, the stream selector is configured to mix in the content as a rendition onto a predetermined object within the channel being viewed.

An embodiment may comprise a profile constructor configured to select keywords for the profile based on detected user interaction.

In an embodiment, the detected user interaction comprises user viewing behavior.

In an embodiment, the detected user interaction comprises user interaction with advertisement material.

In an embodiment, the profile comprises at least one element of the group of elements comprising: a user subscription type, a user age, user sex, a user location, user viewing preferences, real time viewing behavior data, user education level, hobbies, user socio-economic status and real time viewing environment data.

An embodiment may be configured for use as one member of the group consisting of a set top box for at least one television, a set top box for managing a home network of electronic devices, a communication-enabled computer, a multimedia-enabled cellular telephone, and a multimedia-enabled vehicle communication unit.

According to a second aspect of the present invention there is provided a user end communication apparatus for managing broadcast channel input within a user end environment, the apparatus comprising:

a channel probe for obtaining channel context data from a stream at least passing through the user end communication apparatus;

a keyword extractor for extracting channel key information from the channel context data; and

a self-trigger unit for triggering provision of alternative viewing material depending at least partly on the extracted channel key information.

In an embodiment, the alternative viewing material comprises one member of the group consisting of: an alternative video stream, a pop-up window, an on-screen banner, an on-screen user activatable control, a video stream mixed sequentially with a stream currently being viewed, an object projected onto a stream currently being viewed, and a user activatable control projected onto a screen currently being viewed.

According to a third aspect of the present invention there is provided a user end multimedia apparatus for processing data streams for viewing, the apparatus comprising:

a probe configured to monitor at least one of the data streams for content;

an extractor for extracting key information from the content, therefrom to provide a keyword stream for use by the apparatus to enable channel context activities to accompany the streaming.

According to a fourth aspect of the present invention there is provided a system for promotion of impulse buying in association with viewing of a channel stream by providing content in the context of the channel stream, the system comprising:

a probe configured to monitor at least one of the data streams for content;

an extractor for extracting key information from the content, therefrom to provide a keyword stream to establish a current context of the channel stream;

a database of content for comparison with the keyword stream to identify content currently in context with the channel; and

an insertion unit for insertion of identified content into the channel stream; thereby to enable in-context insertion of content to accompany the streaming.

The system may be located at a user end device, thereby to provide the insertions with low latency.

According to a fifth aspect of the present invention there is provided a method of obtaining revenues from broadcasting comprising:

providing users with a system for promotion of impulse buying in association with viewing of a channel stream by providing content in the context of the channel stream, the system comprising:
a probe configured to monitor at least one of the data streams for content;
an extractor for extracting key information from the content, therefrom to provide a keyword stream to establish a current context of the channel stream;
a database of content for comparison with the keyword stream to identify content currently in context with the channel; and
an insertion unit for insertion of identified content into the channel stream; thereby to enable in-context insertion of content to accompany the streaming; and

selling to advertisers the right to have their own content placed in respective databases and associated with predetermined key information.

In an embodiment, the selling comprises providing the right in return for at least one member of the group comprising a one time fee, a per-interaction fee, a per click fee and a fee paid per viewing of a preview by a viewer.

In an embodiment, the content comprises at least one member of the group comprising a screen-style skin, a theme and an icon.

In an embodiment, the content comprises at least one member of the group consisting of a screen-style skin, a theme and an icon.

An embodiment may comprise associating at least some keywords with content of a service provider.

In an embodiment, the content comprises a downloadable application and wherein the selling comprises providing the right in return for at least one member of the group comprising a one time fee, a per-interaction fee, a per click fee and a fee paid per use of the application.

In an embodiment, the content comprises content leading to transactions, wherein the transactions are made through infrastructure of a provider and wherein the selling comprises taking commissions of the transactions.

In an embodiment, the application provides a service and wherein payments for the service are made through infrastructure of a provider.

In an embodiment, the service comprises a voice-related or video-related communication service.

An embodiment may comprise providing a benefit to an end user based upon commissions earned via the selling.

In an embodiment, providing the benefit comprises assigning the benefit based on a user identity number stored in an end user terminal apparatus.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing a user end entertainment or communication management apparatus such as a set top box, according to a first preferred embodiment of the present invention;

FIG. 2 is a simplified diagram showing a user screen to which an embodiment of the present invention has been applied;

FIG. 3 is a simplified block diagram showing the apparatus of FIG. 1 in greater detail;

FIG. 4 is a simplified flow chart showing the process of extracting keywords from a stream and using them to insert items into a mix for viewing according to an embodiment of the present invention;

FIG. 5 is a simplified flow chart showing the extracting of keywords from a stream and their use to trigger an advertising interval according to an embodiment of the present invention;

FIG. 6 is a simplified flow chart showing the extracting of keywords from a stream and their use to provide user activatable pop-ups, or banners or links for user interaction, according to an embodiment of the present invention; and

FIG. 7 is a simplified diagram showing various elements of a user profile for use in embodiments of the present invention.

### DESCRIPTION OF EMBODIMENTS OF THE INVENTION

The present invention relates to apparatus and a method for providing targeted content with broadcast material and, more particularly, but not exclusively to targeted insertion of content into or alongside a broadcast or downloaded stream based at least partly on information available about the stream and/or the viewer.

Such content may be provided in real time based on real time low-latency recognition and extraction from the broadcast stream or any other media or multimedia stream, of subjects, objects, phrases and keywords, for example those that carry commercial or educational meaning and/or are associated with items or services that can be offered for sale. The extracted keywords may then be matched, again in real time and at low latency against a database of advertising material and sales items, or educational and background items etc. etc. The matching may be aided by making use of the viewer's profile, so that the output is both in context and targeted.

In order for the context to be current, the extraction process may be low latency, and this is helped by carrying out the extraction process at the user end. However as an option the extraction may take place at the head end server instead.

The user may thus be provided with targeted content in real time along with broadcast material, or the broadcast material can be paused while the in-context and targeted content is provided to the viewer.

In an embodiment there is provided a user end multimedia apparatus for processing data streams for viewing, comprising: a probe configured to monitor one or more data streams for content. Each data-stream may be for example a live real time stream or a recorded real-time stream; and the data stream may be broadcast to the apparatus, or may be downloaded by the apparatus. The apparatus may further comprise an extractor which extracts keywords or key phrases or key concepts with commercial or other meaning from the stream. Extraction may be on a continuous real-time, on low-latency basis so that the extracted context is current. The result is a low rate keyword/key-phrase/key-concept stream which can be used to provide content in a current channel context, for example providing in-context information or advertising to accompany the stream. Thus a broadcast/downloaded stream can be accompanied by contextual articles giving background on the subject of the multimedia content or in-context activities such as games, icons, skins, themes relating the subject matter or on in-context advertising. The in-context activities may be provided through searches for available content based on data mining of the keyword/key-phrase/key-concept stream.

In general keywords or concepts are extracted from the channel. Concepts are based on context-based machine understanding of the channel material. Hereinafter the term “key information” is used to cover both simple keywords and the processed concepts, and any other information indicating channel content.

In embodiments the data may be targeted based on a combination of context of the channel and a user profile. In an embodiment the targeting is carried out by equipment at the user's home, whether a set-top box or a like device for managing home entertainment, a personal computer (PC), or even by a media playing device itself, such as a mobile telephone.

In one embodiment, standard EPG, TV guide, closed captions, subtitles, program translation and other related data from the broadcast signal are used as a source from which to extract keywords, key-phrases or key-concepts.

In one configuration the head-end server provides a stream of context hints.

Data from any audio or video source can be analyzed for keywords, key-phrases or key-concepts, based on speech and/or video object recognition, and sources may include a broadcast, Internet, local camera or microphone, audio or video streamed from any device such as a video player, a portable player or from a video or music library. The keywords may optionally be filtered using a user profile to refine or personalize the advertisements. The keywords, phrases etc. are then matched against a database or library of advertisements/goods etc. The database can be local or remote, for example Internet-based, or partly local and partly remote. Whenever a keyword/phrase/subject etc. is found a match in such a database, the matching advertisement or other content is inserted, for example either alongside the media stream, superimposed on the media stream, or blended into the media stream, or the media stream may be paused. Any matching goods may be offered for sale, again either alongside the channel or during a pause that is introduced. Filtering of the keywords via the viewer profile may be as follows: if the viewer profile indicates that the viewer might be particularly interested in an item matching a current keyword/key-phrase/key-concept, for example based on accumulated history profile of the user) then such an item may be offered in a more explicit way—for example, the apparatus may automatically suspend or pause the stream while the item is being offered. On the other hand, if the viewer profile indicates a viewer is likely not to be interested in items indicated by the current context, then the advertisement may not be played, or may be played in a less disruptive way. The user profile may include viewing hours, viewing habits including kinds of programs watched and the current program being watched, and even future programs that have been scheduled for watching or recording, and a history of user interactions. Regarding future programs it is noted that the user can use EPG to schedule future programs for watching, and the channel may change automatically to show the program at the specified hour. Additionally, the user can schedule the recording of a program if he knows he will not be home to see it live. The system is therefore able to note that a user has this time scheduled the recording of a show that he usually watches live. The system may therefore understand that the user will be late home that evening and may respond accordingly, for example it may supply the user with a link to pre-order a “late dinner” from a nearby restaurant.

The comparison between the keywords etc. and the database may be a soft comparison using logic rules. If a personal profile is present then for example when there is a match between the program context keywords and a content item in the database, and the user profile indicates viewer interest, content may be offered immediately to the user, which may be connected to the original keywords. Alternatively the system may wait for a trigger from the broadcaster to indicate an advertising break, and then offer the content.

The content may be but is not limited to advertising, and the broadcast stream may be buffered on a local storage device while the content is offered to the user. In this way, advertising breaks may be customized for individual users, and the customization may include the length and timing of the advertising break.

The content may be presented as full screen video, as full screen video blended into the original screen, as video in an-on-screen window, as an on-screen link or banner or the like, and, aside from the full-screen video option, need not interrupt the program at all, unless the user activates the link. If the user does activate such a link, the program may be suspended or paused for the advertisement break, or a pop-up window with the advertisement may appear alongside the original program. The content may even be integrated into the channel, for example advertising hoardings at a sports game may carry slogans selected locally for the individual user.

As a result, advertisers may be persuaded to pay more for better targeted advertising which may also be location based. Viewers may be provided with cheaper or free IPTV, cable or satellite packages based on the level of targeted advertising they are willing to accept. Viewers may be targeted in context, helping to encourage impulse-type buying, especially if the advertising includes active links for on-line ordering.

It is noted that an identical program that is viewed more than once, whether using a personal video recorder, re-broadcast or other techniques, may be associated with different advertisements at each viewing. This may be the result of the different times the program is being viewed being used as part of the keyword selection process, and/or the result of an update to the content/keyword database that has taken place in the meantime.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

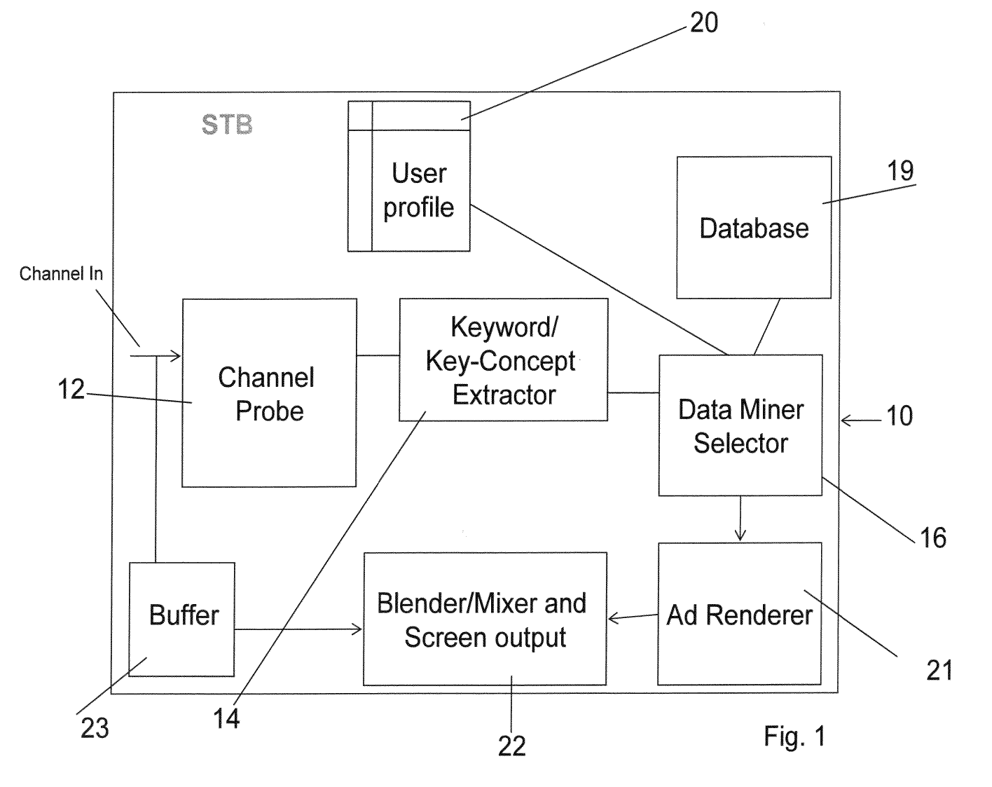

Referring now to the drawings, FIG. 1 illustrates user end communication apparatus 10 such as a set top box (STB) for managing broadcast or download channel input within a user end environment. The apparatus includes a channel probe 12 for obtaining channel context data from a stream that passes through the user end communication apparatus, a keyword extractor 14 for extracting channel keywords, key-phrases or key-concepts from the channel context data, and a data miner/selector 16 for selecting a content item or stream for mixing into a channel currently being viewed based on the channel keyword. The content items for selection are held in a local/remote database 19, as explained below.

It is noted that multiple streams may be analyzed for context data.

In one embodiment, the channel probe 12 obtains channel context data from EPG, closed captions, subtitles, program translation, a stream of context hints inserted by the head end, and other related data included within a broadcast stream, and the keyword extractor 14 looks for channel content suggestive of commercial products or services and the like. Alternatively the channel probe may find out about a commercially suggestive context by obtaining channel context data through image/video analysis applied to the channel. Images/video that are recognized may be replaced by keywords which are then used by the keyword extractor. As a further alternative, the channel probe may obtain channel context data from audio analysis of the channel. Speech to text processing is applied to the audio track and then the recovered text may be used by the keyword extractor. Additionally, audio may be scanned using voice analysis tools to detect speaker sentiment, rhythm, song names, etc. The skilled in the art may appreciate that the embodiments deal with incoming streams which may be processed on a real-time basis. The keyword extractor may output a lower-rate, real time stream of keywords. Alternatively, any combination of the above methods can be used conjunctively.

In one embodiment a combination of two or more of the above methods is used to obtain commercially interesting keywords.

The embodiment includes the content database 19. The selector may match keywords extracted from the channel against the content, including content such as advertisements, goods for sale contained or pointed to from the database 19. The embodiment also includes a profile 20 of the viewer, which can be used by selector 16 to prioritize certain keywords which the profile indicates as important. The profile may be based on the kinds of programs being watched or on user interaction with the programs or with advertisements, or may be based on data voluntarily provided by the user or with data obtained in any other way. The selector may optionally use viewer information contained in viewer profile 20 as matching criteria.

In one embodiment of the invention, the advertisement may be customized according to the user profile. For example, an advertisement may be displayed in different languages according to the native language of the viewer. Another example is an advertisement for a vacation in Florida that automatically calculates the cost of vacation for all family members.

The data mining/search in the database, or its refinement made by the selector, may involve soft comparisons based on logical rules, probabilities and the like, and may result in a determination that now is a good time to show some relevant content or that certain content is both relevant to the current context and of interest to the user.

The selector 16 consequently passes the selected ad to the renderer 21, which renders the content (in one embodiment, the advertisement). The content is displayed on the user screen, either as an interruption to the current media stream, or in addition to the media stream or mixed/rendered into the media stream. The content may be video, or audio, or a still image or a link or a banner, or a pop-up or a new window appearing on the screen or a user activatable control, or just an object rendered within the media stream currently being displayed, but in all cases may be mixed into the overall screen display at mixer/screen output 22.

In the above description the channel that was probed was the channel that is currently being viewed on the screen. However it is possible to obtain context information from other streams passing through the apparatus 10. For example the streams may comprise live or recorded broadcast programs, cable, satellite, IPTV, radio programs, programs stored on peripherals such as HDD or external storage, or downloaded or streamed from Internet or telecommunications sources and the channel probe 12 may probe such a stream in order to obtain keywords which may be assumed to be of current interest to the user. The apparatus may probe the voice over IP (VoIP) stream of digital telephone applications such as Skype™.

In the case of video content, the buffer 23 may buffer the channel being viewed while a content stream related to the keyword that was extracted is played. The buffering may be for an amount of time determined by the content stream or may be a function of the user profile, or a combination of the two. Thus the set top box manages an advertising break that is fully customized for the local user, both in terms of when it occurs, what it contains and the duration thereof.

In one embodiment, the stream selector may mix in the content stream automatically and without any triggers. Alternatively, the stream selector may mix in the content stream following receipt of a trigger from a head end. Alternatively, the stream selector may mix in content following local triggering by a user. For example the user may be shown an on-screen control. If the user activates the control then the program is halted while the user is shown content related to the on-screen control, say associated advertising content. In this way program makers may be able to provide context information or background or source material to interested users to supplement the basic program.

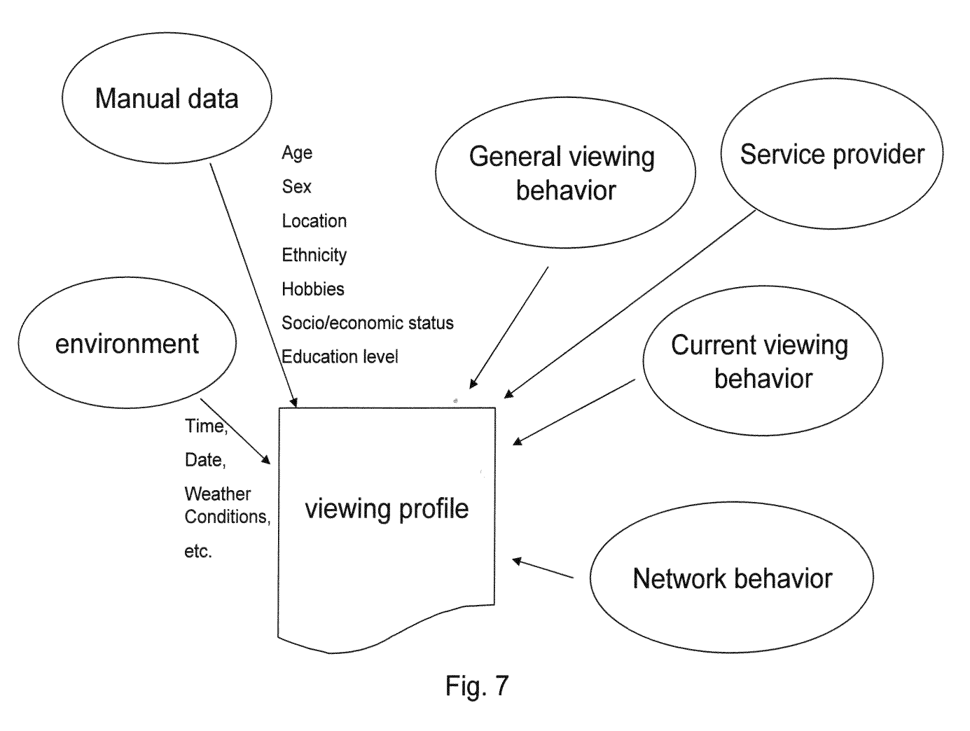

The profile 20 may include a user subscription type, age, sex, education level, social & economic status, hobbies, location, viewing preferences, real time viewing behavior, and real time viewing environment data. Environment data may even include, season and/or temperature and/or time. Thus if increased temperature is detected, the system may start providing advertisements for drinks or air conditioning. A dropping temperature may prompt adverts for coats. If a mealtime is approaching then the system may start providing advertisements for food. Profiling is discussed in greater detail in relation to FIG. 7 below.

As explained, apparatus 10 may be a set top box for a television or group of televisions, a set top box for managing a home network of electronic devices, a communication-enabled computer, a multimedia-enabled cellular telephone, or a multimedia-enabled vehicle communication unit.

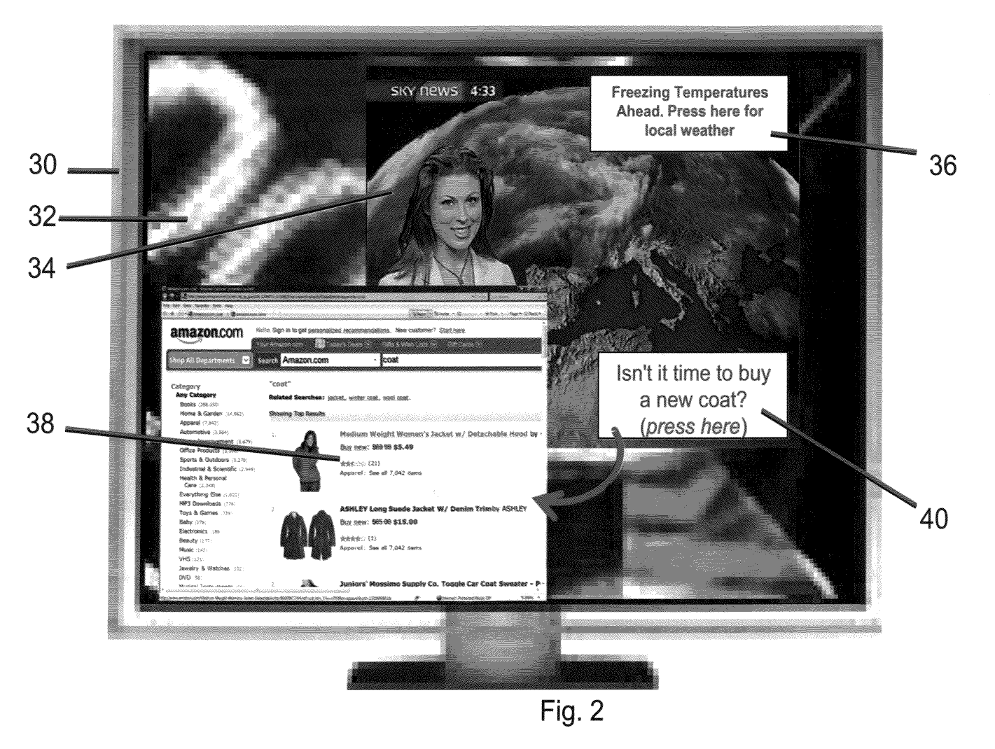

Reference is now made to FIG. 2, which illustrates a screen display being used with the present embodiments. Screen 30 includes a background or wallpaper 32 and a main widescreen display window 34 showing a television channel, including interactive services included with the channel in sub-window 36. A link 40 is displayed over the window 34, and a separate window 38 has opened showing additional, commercially orientated content. The window 38 may have been triggered by use of a keyword by the channel in the main window, or by the user clicking on the active link 40. In the figure, the weatherwoman reports that freezing temperatures are arriving. The apparatus extracts several keywords (such as “low pressure”, “low temperatures”, “freezing”, “cold”, “snow”), refines the search based on the viewer's gender—here it is supposed that the viewer is a woman, and as a result, an advertisement for women's winter clothing is shown. When the viewer clicks she is linked to a website which sells women's winter clothing.

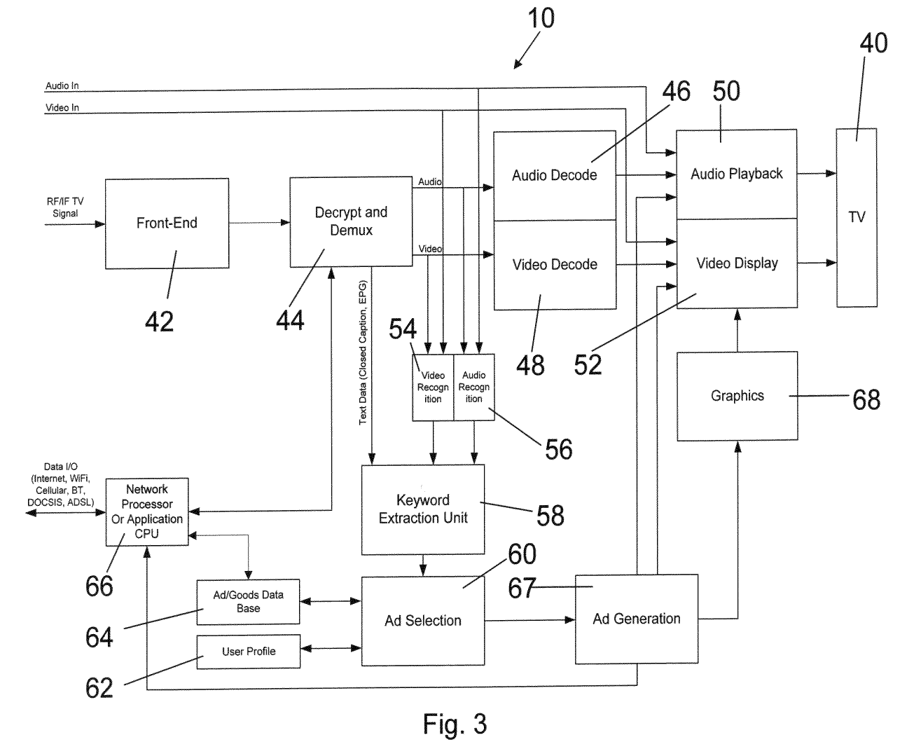

Reference is now made to FIG. 3, which is a simplified block diagram showing the device 10 of FIG. 1 in greater detail. The device 10 is connected to television 40.

An incoming RF/IF or IP, Transport/Program or the like signal is received and demodulated at front end 42, and decrypted and demultiplexed at decrypter and demultiplexer 44, where the audio and video signals are sent to the audio and video decoders 46 and 48 respectively. The decoded output is then passed to audio playback and video display units 50 and 52 respectively and then output to the TV 40. Alternatively uncompressed/unencrypted audio and video are sent directly to audio playback and video display units 50 and 52 and then output to television 40 in the same way. Thus far is conventional.

In addition there are provided video recognition unit 54 and audio recognition unit 56 which probe the incoming channel. Video recognition unit 54 recognizes real-time objects, for example consumer electronics appliances, clothing, foods, etc. as they appear in the video stream. Audio recognition unit 56 recognizes speech and transforms it into text which can later be used for keywords/key-phrases/key concept extraction. Decrypt/Demux unit 44 may also extract and decode closed-caption, sub-titles, EPG, teletext and other digitally transmitted data formats embedded in the broadcast/downloaded stream, for further keyword/key-phrase/key-concept extraction and processing.

The outputs of these units are passed on to low-latency keyword extraction unit 58 which extracts all commercially meaningful keywords, key phrases and key concepts. This output of unit 58 is the lower rate stream of keywords referred to above, which follows the text-data, video recognition or audio recognition input streams to provide real-time context.

In an embodiment data mining techniques are applied to the data extracted from the any of the streams being analyzed, or combination thereof.

Advertisement or content selection unit 60 then uses the extracted keywords, to select advertisements and goods from database 64. Additionally or alternatively, the ad selection unit 60 uses the user profile 62 to filter or refine the ad selection. For example, if a keyword “sports” is extracted and/or recognized by the keyword extraction unit 58, a greater number of ads and goods associated with sports may be highlighted for a user whose profile shows that he/she regularly watches sports. Terms connected with children may be highlighted if the profile shows that this television is often used to watch children's programs. Advertisement/Goods database 64 is an advertisement database, preferably local, which maybe be updated, continuously or from time to time, through the application CPU 66. The database may be downloaded from the head-end and may include pointers associated with expected keywords and purchased links.

The add selection unit 60 may also select appropriate ads from the database 64, based upon a Quality of Service (QoS) mechanism. For example, if a commercial entity is ready to pay more for “air-time” then it could be granted a higher priority, and thus secure more exposure of its ads. QoS may also ensure an even use, that is make sure that a specific commercial is not being held back while other commercials with the same priority are provided with more air-time.

As mentioned above, the keyword search and the advertisement selection are preferably performed at the terminal or user device. Performing these tasks at the remote server in a way that would achieve a real time effect at the user end would require substantial computing resources and throughput. Even if these resources are available, the increased latency involved in the communications with the server and network reliability may result in less effective advertising, thus missing business opportunities and impulse buyers.

Additionally, if the search and selection were to be carried out at the server, then the user profile would have to be available at the server. The presence of such sensitive personal information at a remote server exposes the users' private data to potential security attacks by hackers.

It is noted that the coincidence of terms extracted from the channel with terms shown to be of importance by the user profile may trigger content to be shown so that no external trigger is needed for the content.

The content indicated by the keywords and the advertisement/goods database 64 may be stored on the local device, or it may be obtained via the Internet, say using a world wide web-type link, or it may be narrowcast from the head end as user specific content, or any combination thereof. The material is passed to ad-generation unit 67 where an advertisement is generated as necessary, depending on the nature of the content obtained. Thus if fully operational video is obtained then the generation stage may not be necessary, but in other cases mixing and like operations may be required to prepare content for the screen, generate a window, or render an object onto the channel. The ad generation unit then outputs separate audio and video signals. The audio signal goes to audio playback unit 50, and the video signal goes to video display 52. Additionally or alternatively, the ad is partially or entirely generated by the graphics unit 68 and rendered with the video by the display unit 52. From there the audio and video are mixed with other audio/video data and passed to the television.

The ad selection 60 may report its selections back to the headend along with other usage material such as “clicks” on advertisements, in order for the broadcaster to collect fees from advertisers only for advertisements shown, and/or for clicks on their advertisements.

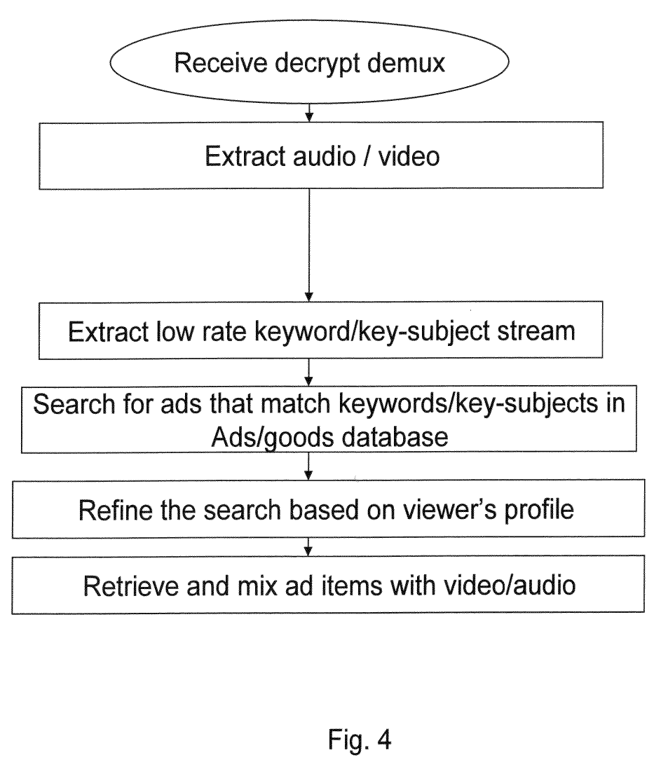

Reference is now made to FIG. 4, which is a simplified diagram showing the flow of the device of FIG. 3. As explained, real time streams passing through the set top box or like apparatus, which may originate from a broadcaster or from a local or remote device, are fed via the audio or video recognizers into the keyword search and classification mechanism, which extracts a low-rate segmented keyword stream.

Subsequently, the keyword stream is fed into the selection unit which compares the stream against advertisement/goods database to identify and select suitable material for a stream of advertisements, and preferably uses the user profile and other data to refine such selection.

Subsequently, the ad generation unit generates commercial content for presentation to the user, in a non-limiting example, using one of the following forms:

1) playing the content in one or more of the following forms: graphics, text links, video, audio, still image or a series of still images;

2) displaying contact information as a banner or an activatable Internet link;

3) automatically opening an Internet browser or window thereof with the appropriate link;

4) sending an email to the user;

5) sending an SMS or MMS to the user; and

6) showing the content on a screen of the remote control.

Any of the forms above may be divided into three groups, preemptive, pre-allocated and viewer triggered.

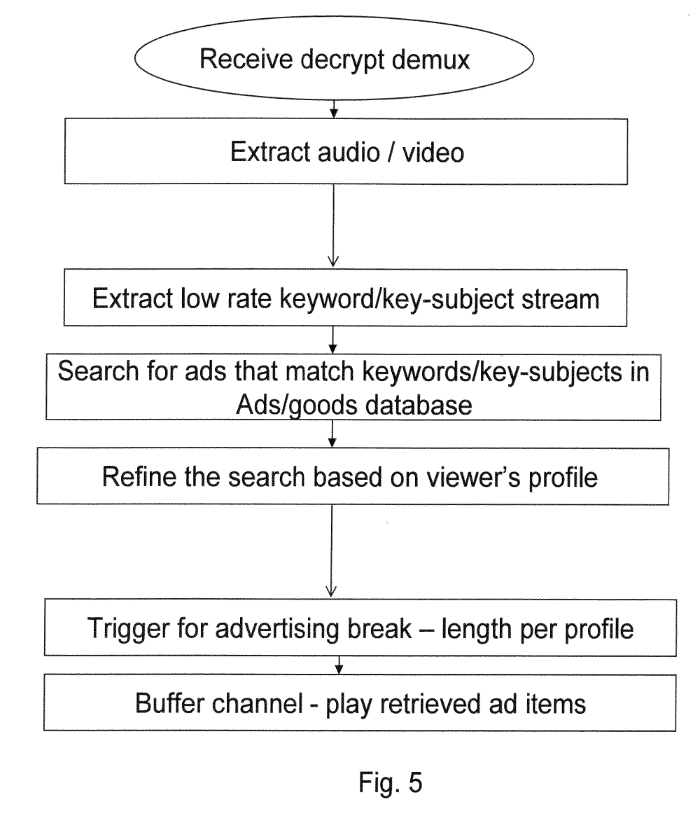

Preemptive content is illustrated in FIG. 5 to which reference is now made. Retrieval of the channel, extraction of the keywords and the identification and retrieval of suitable content is as before. While a show is in progress, the STB can self trigger a commercial break, that is decide autonomously to insert a commercial. The commercial may be inserted by recording the live show to some storage media, in effect buffering the channel, then playing the commercial, and then resuming the show from the storage media while still recording the rest of the show (DVR like).

The trigger may be set when good matches are found between extracted keywords and the ads/goods database, or using viewer profiling, or by use of other methods. The length of the break may be set by the length of the selected content or based on a setting in the user profile or by any other suitable method.

The present embodiments also provide for event driven content. Thus content items such as advertisements may be downloaded or programmed from the head-end, and triggered to appear following certain events or at certain times. Thus for example a certain advertisement may be triggered into action at 2 PM, or when the user has been watching for more than two hours, or watching a certain channel for more than two hours etc. A particular application of the above is for users who wish to ration their television watching. They may program the system to notify them after the television has been on a certain amount of time, or to tell them to go and do their homework after a certain hour has been reached.

The content of the present embodiments extends to subliminal content, for example subliminal advertisements, which can be created via audio signal or message embedded in the video stream, and are designed to pass below the normal limits of perception. These advertisements are thus indiscernible by the conscious mind, but in certain situations are believed to affect the subconscious or deeper mind and later actions or attitudes of the user.

As an alternative, the set top box may rely upon pre-allocated slot commercials—The head end may leave pre-allocated slots for commercials within shows. Then, the STB can scan the show to find these breaks, and insert commercials according to the user profile in the slots set by the head end.

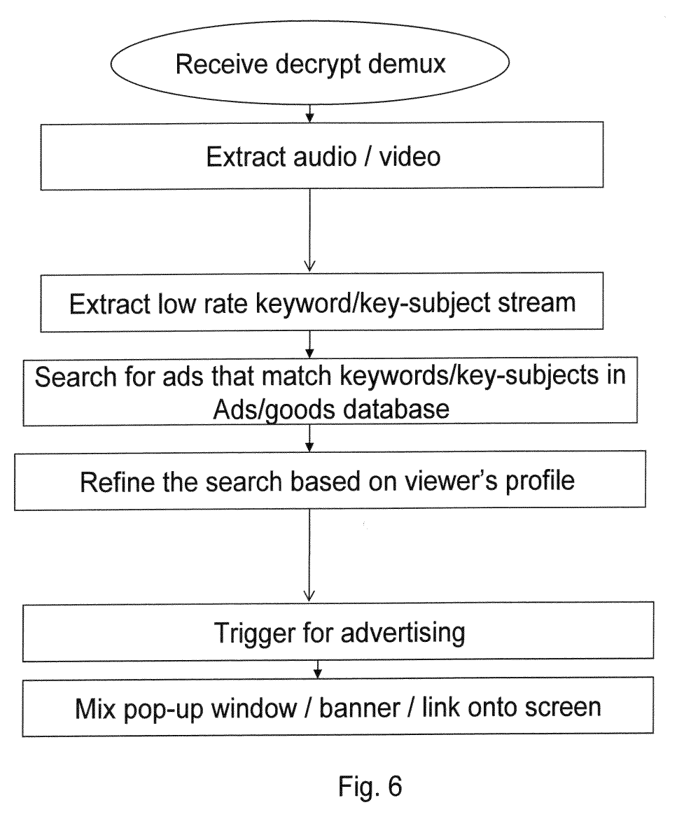

A further alternative is illustrated in FIG. 6. Extraction of keywords and retrieval of advertising content is as described. The retrieved advertising content is then mixed to the current screen display as a pop-up screen or as a click-on banner or link or the like. The viewer then has the option to click and self-trigger the commercials, and/or open the advertiser web-site, or he/she may pause the show to play the ad content. The system can be configured to automatically perform the triggering for the user.

The system can be used to support on-line gambling, viewer authentication and secure financial transactions, as described below.

More particularly, the on-screen banners etc. need not be advertisements. They may also include direct interaction with the current television program. Thus they may offer the viewer to click and enter on-line shopping network, or participate in a game show or place an on-line bet on a live sporting event. On-line betting may include the feature of odds being changed over the course of the event. To date, on-line betting has been plagued by the security issue of authenticating the time of sending of an on-line bet. Delays occur over the Internet and with cellular text messaging, so that the time of sending of a message can be faked to make a message look as though it was sent earlier than it actually was. The set-top box by contrast can use its existing security infrastructure and strong encryption as well as the broadcast timestamp signal to give a time of sending stamp that cannot be forged. The set-top-box existing security infrastructure may greatly help authenticating the user as well as secure the financial transactions, in comparison with less secured environment (i.e., PC based internet transactions).

Reference is now made to FIG. 7 which is a simplified schematic diagram illustrating the user profile and how it may be constituted. First of all the profile is here denoted the viewing profile, since if the device is a set-top box there may be multiple viewers in the household, each with different behaviors. It is noted that the profile may be configured never to leave the set-top box so that privacy can be maintained. Generally the head end is also secured so that others cannot guess from the advertising material retrieved what the settings in the profile are.

Certain data may be manually inserted, such as age, sex, ethnicity, special interests, education level, hobbies, socioeconomic status etc. General viewing behavior can be obtained by the device itself. Thus regular watching of children's channels may reveal the presence of a young audience in the house and analysis of the programs watched may reveal the age and sex of the children. Regular watching of sports channels combined with game shows may indicate a certain profile—typically male, whereas regular watching of sports channels combined with news and current affairs may indicate a male of similar age but of a different social grouping. Regular watching of travel and travel related programs may be used to trigger travel related advertisements etc.

The profiling may note that viewing behavior at certain hours or from a certain television set indicates one profile and viewing behavior at different hours or from a different television set indicates a different profile. Such data may be included on the viewing profile so that different types of content may be sent to what are on the face of it two different viewers.

Regular user behavior may include a history of interaction of the user with the programs and advertisements. Thus if a user has on previous occasions reacted to commercial material on a certain topic then his profile may indicate this.

Current viewing behavior may also be used in the profile. Thus if children's programs indicating young children are regularly watching but currently it is after 9 pm and a health-related program is being watched, it may be assumed that parents of young children are currently watching and may be interested in products to do with child health or even education.

Environmental behavior may also be noted as discussed above. Environmental behavior may include the time, so that food adverts can concentrate on a time when a viewer might be expected to be thinking of food. If a temperature sensor is available then high temperatures may be used as triggers to advertise air conditioning or drinks.

One consequence of using environmental information, including time and date, is that if a viewer were to record a movie and watch it later, different advertisements may be generated for the later watching.

The device may also manage the home communications network including Internet. Thus general Internet behavior, types of websites visited and the like, may also be used to build up the profile of the user.

If location data is provided then local advertisements may be provided. Today local businesses are limited in using television as an advertising media, but if they are able to target their own locality then a whole new sector of television advertising becomes possible.

It is noted that the STB is a very secure environment, so that using existing STB security, any viewer profile s stored thereon is secure and inaccessible to anyone except for the viewer with a very high degree of certainty.

The service provider may be able to add its own information to the profile. Thus the provider may wish to add service announcements, or announce changes to its schedules, route advertisement into its own on-line home shopping network, advertise pay-per-view or other services, or even promote its own brand-name and stock, all according to channel context.

Moving on to the advertisers and instead of purchasing time on television networks as a whole, the present embodiments provide the possibility of purchasing keywords or percentages of keywords, appearance time, and/or user-locations or the like, or they may even purchase advertising based on a fee calculated per user interaction. Links may be tracked using a tracking system inserted on the set top box or other end device, reporting which links have been clicked.

As a secure set-top box is involved, and an IPTV, cable or satellite TV account is required to have a box, pay-per-click is much less subject to the kind of abuse on the Internet. In particular since the set top box is a secure environment that only runs provider-certified software, it is much harder to provide false clicks.

In addition, one of the problematic issues of advertising clicks, as well as with gambling and on-line ordering is identifying who is the user at the end device. Known issues are cheating, often involving use of false identity, possibly obtained by various techniques of identity theft. However in the case of a set-top box, the identity is known at the end device so one cannot program one's set top box to impersonate another box. Rather each STB has its own unique identity, and is linked to a user whose identity/or credit-card is known to the service provider/MSO. Furthermore, the end-device to Head-end communication is generally encrypted, further making false identity, or identity theft harder because initial identity data cannot be obtained by an outsider. The set top boxes further ensure that only certified/signed code can be downloaded and executed, so Trojan horses are excluded as an option, or at least would require infiltration of the provider. In particular the service-provider/MSO has full control over the software stack, thus eliminating external malicious code execution.

A further use of the present embodiments is for the user to be able to customize his viewing experience by purchasing in-context advertised customizations. A user may add features or obtain themes or skins or backgrounds for his/her screen and may order customizations of his user interface. The user may be encouraged to purchase a customization based on a current program that he is watching. A non-limiting example would be for an impulse-buyer to change the background 32 of FIG. 2, with a picture of his favorite team, during a sporting event. For that matter he may be offered a ring-tone for his mobile telephone based on the signature tune of a program he is currently watching.

In the following, the term NRE carries the meaning of “non-recurring engineering cost”, or one-time fee.

The use of the system of the present embodiments may incorporate any of the following:

The operator sells locally defined or nationwide advertisement space to ad-providers, and is paid a non-recurring payment or NRE and/or a per-click fee, or per preview fee, or even per use fee, if say the advertising content includes a reusable application or a service.

The operator may sell icons or skins or themes that relate to content, say a television program, that is being broadcast[. For example, the viewer my purchase a star-wars theme for his set-top box. When the viewer changes the channel, he will see an animation of “Yoda” pulling a curtain from the top of the screen with the next channel. The background would be decorated with pictures of “Yoda” etc. Alternatively, an advertiser, or any third party may sell skins or themes, related to the broadcast content, or just general skins or themes, similarly to ringtones in cell phones. Either way the icons or skins or themes are made available to the end user in association with the content to which they relate, or without any association. The end user pays for the icons or skin and the amount is split between the skin/theme owner and the operator, say on the basis of a NRE and/or a per-use fee.

As mentioned, the operator may advertise its own products or channels on an in-context manner.

The operator may allow a 3^{rd} party application to be downloaded, and would then collect an NRE and/or per-download or per-use fees. The application may provide a service utility to the-end user, or may be an on-line game, etc.

In cases such as on-line games and services, transactions may be paid for through the operator's infrastructure. The operator may collect a fee, say a percentage charge, from transactions made through its billing system.

The applications to be downloaded, or any other content provided, may relate to additional services that the operator may make available, either directly or through third parties. If from third parties then billing may be through the operator's infrastructure, allowing charging of a commission. Such services may include telephony services through VoIP etc.

If a viewer purchases goods/services via any of the ways discussed above, so that the operator makes a commission, the operator may apply the commission as a full or partial deduction from the viewer's monthly bill. Alternatively a viewer may be provided for free or at a discount, services of the operator that otherwise cost money.

In the case of such incentives, should such a viewer reach a certain amount in applied commissions, which may be aggregated monthly or annually, from on-line purchasing, the operator may provide the TV services for free. The number of services provided for free would depend on the commissions applied but may include Internet, voice and even cellular services if the operator also provides these.

The same incentives mentioned for on-line purchasing may be applied in return for bets placed on on-line sporting events and the like or for participating in on-line trivia competitions such as the “who wants to be a millionaire” competition.

Whatever the incentive, the logic used may be based on the operator identifying the viewer using a unique ID stored on the viewer's terminal equipment, typically, the set-top box or STB, and located in the OTP memory thereof. The operator may collect commissions on each bet or purchase or use, and once the commission allocated per viewer reaches a certain level, the service fee may be discounted or nullified.

It is expected that during the life of a patent maturing from this application many relevant kinds of set top box and home entertainment technology will be developed and the scope of the corresponding terms is intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. User end communication apparatus for managing broadcast channel input within a user end environment, the apparatus comprising:
a channel probe for obtaining channel context data from a stream at least passing through said user end communication apparatus;
a keyword extractor for extracting channel key information from said channel context data; and
a content selector for selecting a content item for mixing into a channel currently being viewed based on said channel keyword.

2. The apparatus of claim 1, wherein said channel probe is configured to obtain said channel context data from at least one member of the group comprising closed captions and subtitles included within said stream.

3. The apparatus of claim 1, further comprises a database of content items for selection by said content selector based a comparison with said channel context data.

4. The apparatus of claim 3, wherein said comparison is a soft comparison.

5. The apparatus of claim 1, wherein said channel probe is configured to obtain said channel context data by image analysis of said channel.

6. The apparatus of claim 1, wherein said channel probe is configured to obtain said channel context data from audio analysis of said channel.

7. The apparatus of claim 3, wherein said stream selector comprises a prioritizing unit for making a comparison between said channel key information and a locally stored user profile, thereby to prioritize content items from said database which are indicated as relevant by said user profile.

8. The apparatus of claim 7, wherein said prioritizing unit is configured to make a soft comparison.

9. The apparatus of claim 1, wherein said stream selector is configured to obtain a link to said content stream for mixing, using one of said extracted channel keywords.

10. The apparatus of claim 9, wherein said mixing comprises providing a user activatable control on a screen in association with said channel currently being viewed.

11. The apparatus of claim 1, wherein said stream selector is configured to provide a pop-up window on a screen in association with said channel being played.

12. The apparatus of claim 1 wherein said stream selector is configured to provide a banner display on a screen in association with said channel being played.

13. The apparatus of claim 1, wherein said stream at least passing is said channel being viewed.

14. The apparatus of claim 1, wherein said stream selector is configured to buffer said channel being viewed while a content stream related to said predetermined keyword is mixed into said channel being viewed for playing.

15. The apparatus of claim 14, wherein said buffering is for a variable time set by a length of said content stream.

16. The apparatus of claim 1, wherein said stream selector is configured to mix in said content stream following receipt of a trigger from a head end.

17. The apparatus of claim 1, wherein said stream selector is configured to mix in said content following local triggering by a user.

18. The apparatus of claim 1, wherein said stream selector is configured to mix in said content as a rendition onto a predetermined object within said channel being viewed.

19. The apparatus of claim 7, further comprising a profile constructor configured to select keywords for said profile based on detected user interaction.

20. The apparatus of claim 19, wherein said detected user interaction comprises user viewing behavior.

21. The apparatus of claim 19, wherein said detected user interaction comprises user interaction with advertisement material.

22. The apparatus of claim 7, wherein said profile comprises at least one element of the group of elements comprising: a user subscription type, a user age, user sex, a user location, user viewing preferences, real time viewing behavior data, user education level, hobbies, user socio-economic status and real time viewing environment data.

23. The apparatus of claim 1, configured for use as one member of the group consisting of a set top box for at least one television, a set top box for managing a home network of electronic devices, a communication-enabled computer, a multimedia-enabled cellular telephone, and a multimedia-enabled vehicle communication unit.

24. User end communication apparatus for managing broadcast channel input within a user end environment, the apparatus comprising:
a channel probe for obtaining channel context data from a stream at least passing through said user end communication apparatus;
a keyword extractor for extracting channel key information from said channel context data; and
a self-trigger unit for triggering provision of alternative viewing material depending at least partly on said extracted channel key information.

25. The apparatus of claim 24, wherein said alternative viewing material comprises one member of the group consisting of: an alternative video stream, a pop-up window, an on-screen banner, an on-screen user activatable control, a video stream mixed sequentially with a stream currently being viewed, an object projected onto a stream currently being viewed, and a user activatable control projected onto a screen currently being viewed.

26. A user end multimedia apparatus for processing data streams for viewing, the apparatus comprising:
a probe configured to monitor at least one of said data streams for content;
an extractor for extracting key information from said content, therefrom to provide a keyword stream for use by said apparatus to enable channel context activities to accompany said streaming.

27. A system for promotion of impulse buying in association with viewing of a channel stream by providing content in the context of said channel stream, the system comprising:
a probe configured to monitor at least one of said data streams for content;
an extractor for extracting key information from said content, therefrom to provide a keyword stream to establish a current context of said channel stream;
a database of content for comparison with said keyword stream to identify content currently in context with said channel; and
an insertion unit for insertion of identified content into said channel stream;
thereby to enable in-context insertion of content to accompany said streaming.

28. The system of claim 27, being located at a user end device, thereby to provide said insertions with low latency.

29. A method of obtaining revenues from broadcasting comprising:
providing users with a system for promotion of impulse buying in association with viewing of a channel stream by providing content in the context of said channel stream, the system comprising:
a probe configured to monitor at least one of said data streams for content;
an extractor for extracting key information from said content, therefrom to provide a keyword stream to establish a current context of said channel stream;
a database of content for comparison with said keyword stream to identify content currently in context with said channel; and
an insertion unit for insertion of identified content into said channel stream; thereby to enable in-context insertion of content to accompany said streaming; and
selling to advertisers the right to have their own content placed in respective databases and associated with predetermined key information.

30. The method of claim 29, wherein said selling comprises providing said right in return for at least one member of the group comprising a one time fee, a per-interaction fee, a per click fee and a fee paid per viewing of a preview by a viewer.

31. The method of claim 29, wherein said content comprises at least one member of the group comprising a screen-style skin, a theme and an icon.

32. The method of claim 30, wherein said content comprises at least one member of the group consisting of a screen-style skin, a theme and an icon.

33. The method of claim 29, comprising associating at least some keywords with content of a service provider.

34. The method of claim 29, wherein said content comprises a downloadable application and wherein said selling comprises providing said right in return for at least one member of the group comprising a one time fee, a per-interaction fee, a per click fee and a fee paid per use of said application.

35. The method of claim 29, wherein said content comprises content leading to transactions, wherein said transactions are made through infrastructure of a provider and wherein said selling comprises taking commissions of said transactions.

36. The method of claim 34, wherein said application provides a service and wherein payments for said service are made through infrastructure of a provider.

37. The method of claim 36, wherein said service comprises a voice-related or video-related communication service.

38. The method of claim 30, further comprising providing a benefit to an end user based upon commissions earned via said selling.

39. The method of claim 38, wherein providing said benefit comprises assigning said benefit based on a user identity number stored in an end user terminal apparatus.
